(19) United States
(12) Patent Application Publication
(10) Pub. No.: US 2013/0021321 A1
(43) Pub. Date: Jan. 24, 2013

(54) LCD device and a related driving method

(71) Applicant: Chihtsung Kang, Shenzhen (CN)

(72) Inventor: Chihtsung Kang, Shenzhen (CN)

(73) Assignee: Shenzhen China Star Optoelectronics Technology Co., Ltd., Shenzhen, Guangdong (CN)

(21) Appl. No.: 13/375,226

(22) PCT Filed: Aug. 25, 2011
(86) PCT No.: PCT/CN2011/078949

§ 371 Date: Nov. 30, 2011

(30) Foreign Application Priority Data
Jul. 20, 2011 (CN) 201110203461.5

(51) Int. Cl. G09G 3/36; G06F 3/038

(52) U.S. Cl. 345/215; 345/87

(57) ABSTRACT

The present invention proposes a LCD device and a driving method thereof. Before required data voltage is applied on each pixel, each pixel is pre-charged to a high voltage level by adjusting outputted voltage level of a common line, thereby over-driving each pixel. The present invention also discloses a method of driving a LCD device. The present invention does not need the frame buffer such that the cost is reduced. Furthermore, a complicated timing function is not required to perform the over-driving operation. Moreover, the liquid crystal molecules of the pixels are not instantly driven to rotate through an incorrect angle if a prior art method of looking up tables to perform the over-driving operation.

### BACKGROUND OF THE INVENTION

1. Field of the Invention

The invention relates to a display and a related driving method, and more particularly, to an LCD device and a related driving method for driving the LCD device.

2. Description of the Prior Art

Over-driving technique is often used to improve the display quality of the LCD device. Conventionally, the over-driving technique is accomplished by looking up a table according to the previous and a current frame data to find out a predetermined interpolated voltage, and providing the over-driving voltage on the pixel to reduce the response time.

However, a frame buffer is required to store the previous frame such that the previous frame can be compared with the current one. Furthermore, the above-mentioned predetermined interpolated voltages are also needed to be stored inside a storage device. Moreover, a timing controller (TCON) is also required.

Please refer to FIG. 1, which depicts the over-driving operation accomplished by a column-driving configuration. Here, the original signal is transformed from 1V to 3V. In order to improve the response speed, a signal 5V is often inserted into the original signal. When the voltage of the pixel changes from 1V to 3V, it needs one frame period to perform the charging operation such that a 5V voltage can be obtained.

For PVA panel, because a high transmittance is required, each pitch between two adjacent grid electrodes of the pixel electrodes is designed to be greater. In this case, if only one set of interpolated voltages are recorded inside the look-up table, the liquid crystals may be driven instantly to rotate through an incorrect angle. This also introduces an overshooting phenomenon when the pixel is transformed from a low gray level to a high gray level such that the display quality is reduced.

Therefore, an LCD device and a driving method for driving the LCD device are required to solve the above-mentioned problem.

### SUMMARY OF THE INVENTION

It is therefore one of the primary objectives of the claimed invention to provide an LCD device to solve the problem of the ineffective display of the prior art.

According to the present invention, a liquid crystal display (LCD) display comprises a scan driving module, for generating scan signals; data driving module, for generating data signals; a thin film transistor (TFT) array panel having pixels, each of the pixels comprises a sub-pixel R, a sub-pixel G, and a sub-pixel B; scan lines, coupled to at least one sub-pixel of the pixels, for receiving the scan signals from the scan driving module to row-by-row scan the sub-pixels located on a same column; data lines, coupled to at least one sub-pixel of the pixels, for receiving the data signals from the data driving module, and for pre-charging the sub-pixel before transferring the data signals to the sub-pixel; and common lines, coupled to the sub-pixels of the pixels, for providing a high voltage level or a low voltage level according to polarities of the sub-pixels coupled to the common lines. The common lines and the data lines are parallel to the scanning direction of the scan signals. The scan lines are perpendicular to the scanning direction of the scan signals. The sub-pixels R, G and B are arranged in a direction parallel to the scanning direction of the scan signals. Two adjacent sub-pixels of two respective pixels located in a horizontal direction have opposite polarities. Two adjacent sub-pixels of two respective pixels located in a vertical direction have identical polarity. Each common line is coupled to the sub-pixels of the same pixel having the identical polarity, and each data line is coupled to the sub-pixels of the same pixel having the identical polarity. The polarities of all sub-pixel of the same pixel are identical.

In one aspect of the present invention, a high or low voltage level is repeatedly transmitted to the sub-pixels of different rows based on the polarity of the sub-pixels via the common lines.

In another aspect of the present invention, a high or low voltage level is alternatively transmitted to the sub-pixels of different columns based on the polarity of the sub-pixels via the common lines.

According to the present invention, A liquid crystal display (LCD) device comprises a scanning driving module for transmitting scan signals to a scan line; a data driving module for transmitting data signals to a data line; a thin film transistor array panel comprising a plurality of pixels, one pixel comprising a sub-pixel R, a sub-pixel G and a sub-pixel B; the scan lines coupled to the sub-pixels in the pixel, for transmitting the scan signals to the sub-pixels on the same row; the data lines coupled to at least one of the sub-pixels of the pixels for transmitting the data signal to the sub-pixels, and for pre-charging the sub-pixels before the data signal is transmitted to the sub-pixels; common lines coupled to the sub-pixels of the pixels, for supplying a high or low voltage level to the sub-pixels according to polarities of the sub-pixels. The common lines and the data lines are parallel with a scanning direction of the scan signals, and the scan lines are perpendicular to the scanning direction of the scan signals.

In one aspect of the present invention, the high or low voltage levels are repeatedly transmitted to the sub-pixels of different rows via the common lines.

In one aspect of the present invention, the high or low voltage levels are alternatively transmitted to the sub-pixels of different columns via the common lines.

In one aspect of the present invention, an arrangement of the three sub-pixels in the pixels is parallel with the scanning direction of the scanning signal.

In one aspect of the present invention, a polarity of one sub-pixel of a pixel is opposite to that of a sub-pixel of an adjacent pixel.

In one aspect of the present invention, each common line is coupled to the sub-pixels with the same polarity of the same pixel.

In one aspect of the present invention, each data line is coupled to the sub-pixels with the same polarity of the same pixel.

In one aspect of the present invention, the polarity of each sub-pixel of the same pixel is identical.

According to the present invention, a driving method for driving an LCD device is provided. The LCD device comprises a scan driving module, a data driving module, a TFT array panel, scan lines, and data lines. The TFT array panel has pixels, each of the pixels comprises a sub-pixel R, a sub-pixel G, and a sub-pixel B. The common lines are parallel to the scanning direction of the scan signals. The driving method comprises (A)utilizing the scan driving module to generate scan signals and transferring the scan signals to the scan lines; (B)utilizing the data driving module to generate data signal and transferring the data signals to the data lines; (C)utilizing the scan lines to transfer the scan signals to at least one sub-pixel of the pixels to row-by-row scan sub-pixels located in a same column; (D)utilizing the data lines to pre-charge at least one sub-pixel of the pixels, before the data driving module transfers the data signals to the sub-pixel; and (E)utilizing common lines to provide a high voltage or a low voltage to the sub-pixels coupled to the common lines.

In one aspect of the present invention, the step (E) further comprises (E1)utilizing common lines to repeatedly transmitting the high or low voltage level to the sub-pixels of different rows, or alternatively transmitting the high or low voltage level to the sub-pixels of different columns.

In contrast to the related art, the present invention does not need the frame buffer such that the cost is reduced. Furthermore, a complicated timing function is not required to perform the over-driving operation. Moreover, the liquid crystal molecules of the pixels are not instantly driven to rotate through an incorrect angle if a prior art method of looking up tables to perform the over-driving operation.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an over-driving operation according to the prior art.

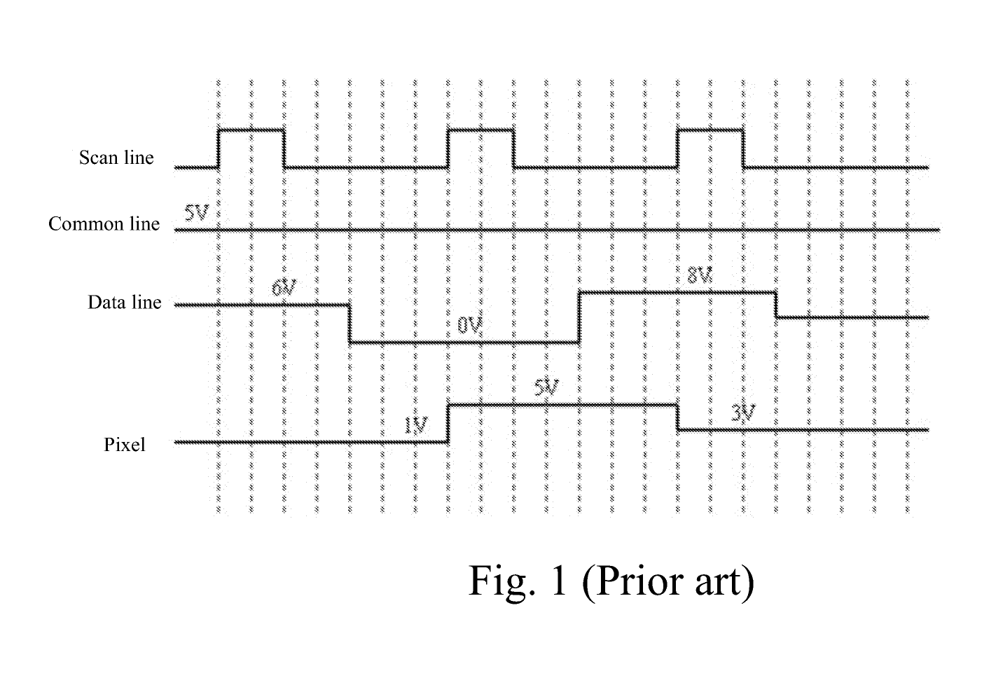

FIG. 2 shows a block diagram of the LCD device according to a preferred embodiment of the present invention

FIG. 3 shows a local diagram of the LCD device according to the first embodiment of the present invention.

FIG. 4 is a diagram showing driving signals of the LCD device according to the present invention.

### DETAILED DESCRIPTION OF THE PREFERRED EMBODIMENT

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

In the following disclosure, units having similar function are labeled as the same number.

The LCD device of the present invention utilizes a high voltage to charge pixels before the data signals are inputted into the pixels through the pre-charge operation and high/low level signals of the array common lines. This is equal to perform an over-driving operation before the data signals are inputted into the pixels.

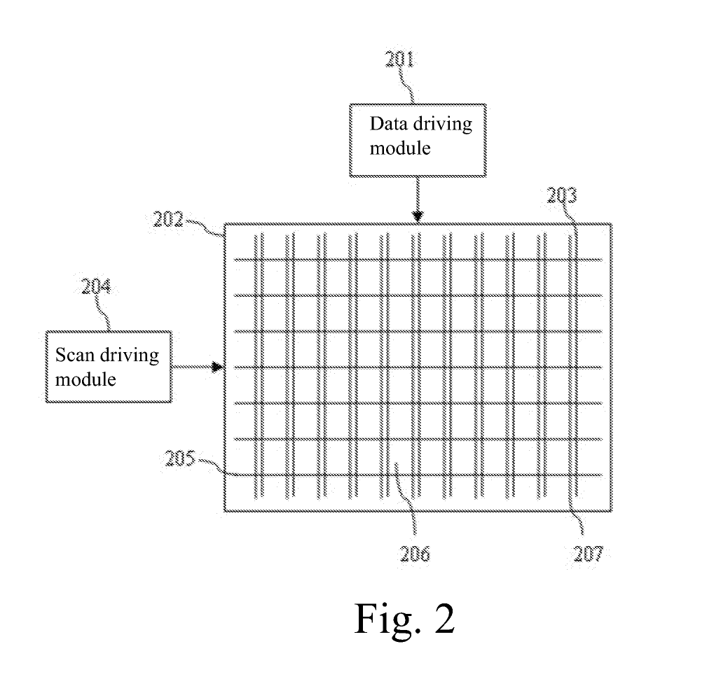

Referring to FIG. 2 showing a block diagram of the LCD device according to a preferred embodiment of the present invention, the LCD device comprises a scan driving module 204, a data driving module 201, a thin film transistor array panel 202, a scan line(gate line) 205, a common line 203 and a data line 207. In FIG. 2, the common line 203 is parallel with the data line 207. The thin film transistor array panel 202 comprises pixels 206, each of which comprises three sub-pixels which are not shown in FIG. 2. The scan driving module 204 transmits a scan signal to the scan line 205. The data driving module 201 transmits a data signal to the data line 207. The scan line 205 is coupled to the pixel 206. Specifically, the scan line 205 is coupled to at least one of the sub-pixels of the pixel 206. The data line 207 is coupled to the pixel 206. Specifically, the data line 207 is coupled to at least one of the sub-pixels of the pixel 206. The common line 203 is coupled to the pixel 206. Specifically, the common line 203 is coupled to at least one of the sub-pixels of the pixel 206.

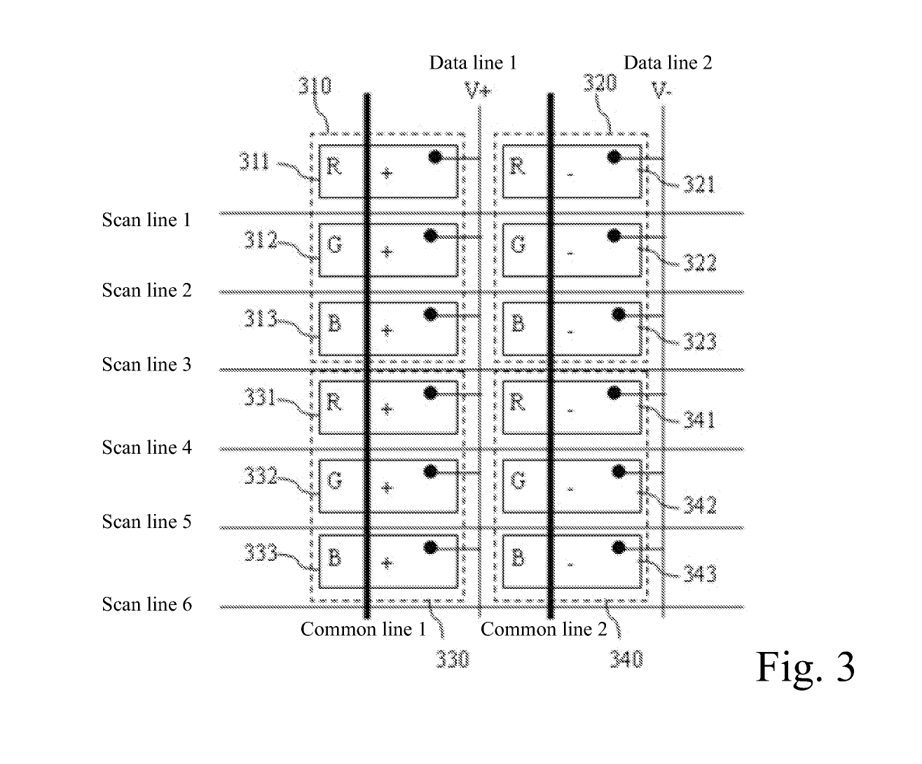

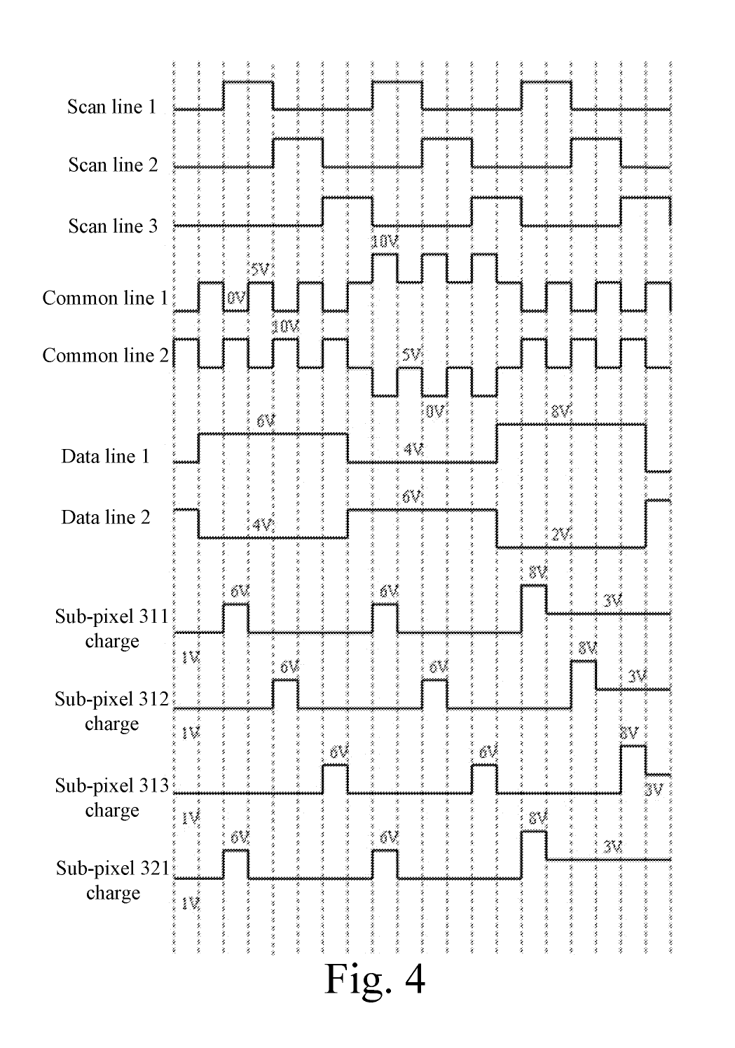

Referring to FIG. 3 and FIG. 4, FIG. 3 shows a local diagram of the LCD device according to the first embodiment of the present invention. FIG. 4 is a diagram showing driving signals of the LCD device according to the present invention. In this embodiment, a tri-gate pixel comprises three sub-pixels (sub-pixel R, sub-pixel G, and sub-pixel B). The sub-pixel R, the sub-pixel G, and the sub-pixel B are arranged in a column parallel with the scanning direction. The scan lines of the LCD device sequentially transmit the scanning signal row by row. The sub-pixel R, the sub-pixel G and the sub-pixel B arranged in a column parallel with the scanning direction. The data lines (containing a data line 1 and a data line 2) are parallel to an orientation of an arrangement of the sub-pixel R, the sub-pixel G and the sub-pixel B. In the embodiment, each pixel in a column of the thin film transistor panel receives the same polarity signal; that is the three sub-pixels in each pixel receive the same polarity signal. The polarities of pixels in two adjacent columns, however, are opposite to each other. The data line 1 for transmitting a first polarity data signal (e.g. a positive polarity data signal) is coupled to a sub-pixel R311, a sub-pixel G312 and a sub-pixel B313 of the first pixel 310, as well as a sub-pixel R331, a sub-pixel G332 and a sub-pixel B333 of the third pixel 330. On the other hand, the data line 2 for transmitting a second polarity data signal (e.g. a negative polarity data signal) is coupled to a sub-pixel R321, a sub-pixel G322 and a sub-pixel B323 of the second pixel 320 as well as a sub-pixel R341, a sub-pixel G342 and a sub-pixel B343 of the fourth pixel 340. The common lines (containing the common line 1 and the common line 2) arranged in an array are parallel with the scanning direction. Each common line is coupled to the sub-pixels in the same column. More specifically, the common line 1(com 1) is coupled to the sub-pixel R311, the sub-pixel G312 and the sub-pixel B313 of the first pixel 310 as well as the sub-pixel R331, the sub-pixel G332 and the sub-pixel B333 of the third pixel 330. On the other hand, the common line 2 (com 2) is coupled to the sub-pixel R321, the sub-pixel G322 and the sub-pixel B323 of the second pixel 320 as well as the sub-pixel R341, the sub-pixel G342 and the sub-pixel B343 of the fourth pixel 340. The first row sub-pixel comprises the sub-pixel R311 of the first pixel 310 and the sub-pixel R321 of the second pixel 320, and the second row sub-pixel comprises the sub-pixel G312 of the first pixel 310 and the sub-pixel G322 of the second pixel 320. The rest may be deduced from analogy. The common lines are parallel with the data lines. The common lines, however, are perpendicular to the scan lines (the gate lines).

Referring to FIG. 4, since each pixel is pre-charged to 8V by the data signal in the same frame before a variety of the charging voltage applied on the pixel from 1V to 3V, the LCD device of the present invention does not need to take another frame time period to charge each pixel. The charging voltage of 1V applied to the pixel is provided by a voltage difference between a data signal of 6V and a common voltage signal of 5V or between a data signal of 4V and a common voltage signal 5V. Similarly, the charging voltage of 3V applied to the pixel is provided by a voltage difference between a data signal of 8V and a common voltage signal of 5V or between a data signal of 2V and a common voltage signal of 5V. A voltage of 8V for pre-charging the pixel is provided by a voltage difference between a data signal of 8V and a common voltage signal of 0V or between a data signal of 2V and a common voltage signal of 10V. The voltage of 8V for pre-charging the pixel is provided at a moment prior to a change of the charging voltage applied on the first row sub-pixel (containing the sub-pixel R311 of the first pixel 310 and the sub-pixel R321 of the second pixel 320) from 1V to 3V when the first scan signal turns on the first row sub-pixel.

When the first scan signal turns on the first row sub-pixels, the sub-pixel R311 is pre-charged by a 8V voltage difference between the positive data signal of 8V and a drop of the common voltage from the common line 1 from 5V to 0V. Meanwhile, the sub-pixel R321 is also pre-charged by a 8V voltage difference between the negative data signal of 2V and a common voltage of 10V from the common line 2. Subsequently, the common voltage from the common line 1 returns from 0V to 5V, while the common voltage from the common line 2 returns from 10V to 5V. In the meantime, the voltage of the sub-pixel R311 and the sub-pixel R321 restores from the pre-charged voltage 8V to normal voltage 3V. And then, the first row sub-pixels are turned off due to a low voltage level of the first scan signal being applied. When the second scan signal turns on the second row sub-pixels (including the sub-pixel G312 of the first pixel 310 and the sub-pixel G322 of the second pixel 320), the second row sub-pixels are pre-charged by a 8V voltage difference between the data signal of 8V and a common voltage of 0V or between the data signal of 2V and a common voltage of 10V. The voltage of 8V for pre-charging the pixel is provided at a moment prior to a change of the charging voltage applied on the second row sub-pixels (containing the sub-pixel R312 of the first pixel 310 and the sub-pixel R322 of the second pixel 320) from 1V to 3V when the second scan signal turns on the second row sub-pixels.

When the second scan signal turns on the second row sub-pixels, the sub-pixel G312 is pre-charged by a 8V voltage difference between the positive data signal of 8V and a drop of the common voltage from the common line 1 from 5V to 0V. Meanwhile, the sub-pixel G322 is also pre-charged by a 8V voltage difference between the negative data signal of 2V and a common voltage of 10V from the common line 2. Afterwards, the common voltage from the common line 1 returns from 0V to 5V, while the common voltage from the common line 2 returns from 10V to 5V. In the meantime, the voltage of the sub-pixel G312 and the sub-pixel G322 restores from the pre-charged voltage 8V to normal voltage 3V. And then, the second row sub-pixels are turned off due to a low voltage level of the second scan signal being applied. Subsequently, the third scan signal turns on the third row sub-pixels. The sub-pixels on following rows are repeated by the above mentioned way in sequence until all rows in a frame are scanned, thereby realizing the over-driving operation.

As an improvement of the LCD device according to the present invention, either a high or low voltage level is repeatedly transmitted to the sub-pixels of different rows based on the polarity of the sub-pixels via the common line 1 or the common line 2, or a high or low voltage level is alternatively transmitted to the sub-pixels of different columns based on the polarity of the sub-pixels via the common line 1 or the common line 2.

Briefly summarized, the method of the signal driving of the LCD device according to the present invention comprises the following steps: the scanning driving module 204 transmits a scan signal to the scan line 205; the data driving module 201 transmits a data signal to the data line 207; the scan signal transmits to at least one of the sub-pixels in the pixel 206 via the scan line 205 and turns on the sub-pixels in the same column; the data signal pre-charges one of the sub-pixel of the pixel 206 before the data signal transmits to the sub-pixel via the data line 207; a high or low voltage level from the common line 203 is applied to the sub-pixel according to the polarity of the sub-pixel. More specifically, either a high or low voltage level is repeatedly transmitted to the sub-pixels of different rows based on the polarity of the sub-pixels via the common line 203, or a high or low voltage level is alternatively transmitted to the sub-pixels of different columns based on the polarity of the sub-pixels via the common line 203.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A liquid crystal display (LCD) display, characterized in that the LCD comprises:
a scan driving module, for generating scan signals;
a data driving module, for generating data signals;
a thin film transistor (TFT) array panel having pixels, each of the pixels comprises a sub-pixel R, a sub-pixel G, and a sub-pixel B;
scan lines, coupled to at least one sub-pixel of the pixels, for receiving the scan signals from the scan driving module to row-by-row scan the sub-pixels located on a same column;
data lines, coupled to at least one sub-pixel of the pixels, for receiving the data signals from the data driving module, and for pre-charging the sub-pixel before transferring the data signals to the sub-pixel; and
common lines, coupled to the sub-pixels of the pixels, for providing a high voltage level or a low voltage level according to polarities of the sub-pixels coupled to the common lines;
wherein the common lines and the data lines are parallel to the scanning direction of the scan signals, the scan lines are perpendicular to the scanning direction of the scan signals;
wherein the sub-pixels R, G and B are arranged in a direction parallel to the scanning direction of the scan signals;
wherein two adjacent sub-pixels of two respective pixels located in a horizontal direction have opposite polarities, two adjacent sub-pixels of two respective pixels located in a vertical direction have identical polarity;
wherein each common line is coupled to the sub-pixels of the same pixel having the identical polarity, and each data line is coupled to the sub-pixels of the same pixel having the identical polarity;
wherein the polarities of all sub-pixel of the same pixel are identical.

2. The LCD device of claim 1, characterized in that a high or low voltage level is repeatedly transmitted to the sub-pixels of different rows based on the polarity of the sub-pixels via the common lines.

3. The LCD device of claim 1, characterized in that a high or low voltage level is alternatively transmitted to the sub-pixels of different columns based on the polarity of the sub-pixels via the common lines.

4. A liquid crystal display (LCD) device, comprising:
a scanning driving module for transmitting scan signals to scan lines;
a data driving module for transmitting data signals to data lines;
a thin film transistor array panel comprising a plurality of pixels, one pixel comprising a sub-pixel R, a sub-pixel G and a sub-pixel B;
the scan lines coupled to the sub-pixels in the pixel, for transmitting the scan signals to the sub-pixels on the same column;
the data line coupled to at least one of the sub-pixels of the pixels for transmitting the data signal to the sub-pixels, and for pre-charging the sub-pixels before the data signal is transmitted to the sub-pixels;
common lines coupled to the sub-pixels of the pixels, for supplying a high or low voltage level to the sub-pixels according to polarities of the sub-pixels;
wherein the common lines and the data lines are parallel with a scanning direction of the scan signals, and the scan line is perpendicular to the scanning direction of the scan signals.

5. The LCD device of claim 4, characterized in that high or low voltage levels are repeatedly transmitted to the sub-pixels of different rows via the common lines.

6. The LCD device of claim 4, characterized in that high or low voltage levels are alternatively transmitted to the sub-pixels of different columns via the common lines.

7. The LCD device of claim 4, characterized in that an arrangement of the three sub-pixels in the pixels is parallel with the scanning direction of the scanning signal.

8. The LCD device of claim 4, characterized in that a polarity of one sub-pixel of a pixel is opposite to that of a sub-pixel of an adjacent pixel.

9. The LCD device of claim 8, characterized in that each common line is coupled to the sub-pixels with the same polarity of the same pixel.

10. The LCD device of claim 8, characterized in that each data line is coupled to the sub-pixels with the same polarity of the same pixel.

11. The LCD device of claim 8, characterized in that the polarities of all sub-pixel of the same pixel are identical.

12. A driving method for driving an LCD device, characterized in that: the LCD device comprises a scan driving module, a data driving module, a TFT array panel, scan lines, and data lines, the TFT array panel have pixels, each of the pixels comprises a sub-pixel R, a sub-pixel G, and a sub-pixel B, the common lines are parallel to the scanning direction of the scan signals, the driving method comprises:
(A) utilizing the scan driving module to generate scan signals and transferring the scan signals to the scan lines;
(B) utilizing the data driving module to generate data signal and transferring the data signals to the data lines;
(C) utilizing the scan lines to transfer the scan signals to at least one sub-pixel of the pixels to row-by-row scan sub-pixels located in a same column;
(D) utilizing the data lines to pre-charge at least one sub-pixel of the pixels, before the data driving module transfers the data signals to the sub-pixel; and
(E) utilizing common lines to provide a high voltage or a low voltage to the sub-pixels coupled to the common lines.

13. The driving method of claim 12, characterized in that the step (E) further comprises:
(E1) utilizing common lines to repeatedly transmitting the high or low voltage level to the sub-pixels of different rows, or alternatively transmitting the high or low voltage level to the sub-pixels of different columns
